(19) United States
(12) Patent Application Publication
(10) Pub. No.: US 2017/0124644 A1
(43) Pub. Date: May 4, 2017

(54) DIFFERENTIAL DELIVERY OF LOAN APPLICATION CONTENT TO APPLICANTS ON MOBILE DEVICES, AND OTHER DIFFERENTIAL CONTENT DELIVERY

(71) Applicant: EFT Network, Inc., Hawthorne, NY (US)

(72) Inventor: Steven Davis, Hawthorne, NY (US)

(21) Appl. No.: 15/343,764

(22) Filed: Nov. 4, 2016

Related U.S. Application Data
(60) Provisional application No. 62/250,679, filed on Nov. 4, 2015.

(51) Int. Cl. G06Q 40/02; H04W 4/02

(52) U.S. Cl. CPC G06Q 40/025; H04W 4/02

(57) ABSTRACT

Differential state-specific content delivery depending on user actual geographic location by state within the United States is provided. Some uses for the technology include consumer loan application-processing systems, consumer leasing application-processing systems, and insurance claims-processing systems.

### FIELD OF THE INVENTION

The invention generally relates to technology in support of consumer lending and leasing operations, especially to technology in support of multi-state consumer lending and leasing operations.

### BACKGROUND OF THE INVENTION

Despite the growth of online business for certain consumer transactions (such as Amazon for online consumer shopping; Ebay for online consumer shopping; etc.), consumer lending and leasing operations still tend to be bricks-and-mortar operations that operate by seeing customers on-premises. Laws and regulations applicable to certain consumer transactions (such as consumer lending) vary from state-to-state, and a consumer transaction that might be conducted in a manner that would be considered compliant in one state might be non-compliant in another state. The complexities presented have interfered with such businesses being able to scale up, expand, and/or offer means for customers to apply beyond in-person applications, consequently keeping costs of these businesses relatively high compared to, say, cost savings achieved in recent years by merchandisers.

A website “https://loanbyphone.com” appears to take certain loan applications by mobile phone. The homepage includes five specific state-based notices, namely, “Notice to CA customers”, “Notice to TX customers”, “Notice to UT customers”, “Notice to LA customers” and “Notice to OH customers”. The “license” page lists certain states, but not, for example, Maryland, New York, Virginia, etc. As the initial communication, Loanbyphone receives user-typed information including name and zip code. In response, the system generates a response screen in which the city and state corresponding to the user-entered zip code are auto-filled. If, for example, a zip code 21218 is user-typed, the loanbyphone.com system auto-generates a screen associating “21218” with “Baltimore, Md.” and showing a message “Thank you—unfortunately we are not accepting online applications in your state at this time”.

One can imagine that some loan applicants might then try typing a different address, such as, for example, where a family member or friend lives.

Many consumer lending or leasing businesses may be unwilling to proceed based on user-typed zip codes (or other user-typed geographic location) as used in the loanbyphone.com system, and remain as bricks and mortar operations.

A consumer lending or leasing business theoretically might want to be able to transact with a consumer who is not in the storefront in person, but thus far there have been unmet needs for practical systems and technology that won't subject the businesses to exposure for non-compliant transactions with out-of-state consumers.

### SUMMARY OF THE INVENTION

The invention addresses the above-mentioned problems and, in a preferred embodiment, provides a system comprising: a computer system comprising a server system and configured to receive incoming data files from mobile telephone devices and further configured to receive GPS location data from mobile telephone devices; a library of state-specific content stored in compartmentalized manner by state for a plurality of states S1 . . . Sn; a plurality of mobile telephone devices M1 . . . Mn each capable of transmitting GPS location; and wherein the computer system performs steps comprising: receiving an incoming communication from a mobile telephone device while receiving GPS location data from the mobile telephone device; and shielding the mobile telephone device that has communicated with the computer system from being sent, in an outgoing communication by the computer system back to the mobile telephone device, any content from the library other than state-specific content from a compartment for the exact state that is the state housing the GPS coordinates of the GPS location data received from the mobile phone device.

In another preferred embodiment, the invention provides technology embodying a method of differential content delivery depending on user actual geographic location in the United States, comprising: receiving (performed by a first computer system) a GPS location from a telephone device, followed by, as a function of what state (such as, e.g. New Jersey) contains the received GPS location, transmitting (performed by the first computer system), to the telephone device, content that is state-specific to the state that contains the received GPS location, such as, e.g., inventive methods of differential content delivery depending on user actual geographic location in the United States, comprising: receiving a GPS location from a telephone device, wherein the GPS-location receiving step is performed by a first computer system; maintaining, performed by the first computer system, in compartmentalized state-by-state manner, a series of content S1 . . . Sn, wherein the content S1 is rated as permissible to deliver to users located in State1, and content Sn is rated as permissible to deliver to users located in State “n”; and electronically delivering state-specific content to the telephone device, wherein the electronically delivering step is performed by the first computer system.

### BRIEF DESCRIPTION OF THE DRAWINGS

FIGS. 1-1A are flow charts of method steps in embodiments of the invention.

FIGS. 2-2A are examples of tables useable in maintaining step 130 in FIG. 1A, in which linked state-specific content is a set of state-specific consumer loan applications.

FIG. 3 is a diagram (not drawn to scale) of an inventive automated system in which is practiced inventive steps 100, 300.

### DETAILED DESCRIPTION OF A PREFERRED EMBODIMENT

In a preferred embodiment of the invention, technology in support of differential content delivery and application-processing depending on user geographic location in the United States is provided. One example of a “geographic location” is a certain state (such as, e.g., New Jersey). Another example of a “geographic location” is a set of GPS coordinates. By “user actual geographic location”, we mean where the user is actually physically present at an increment of time on the order of a time stamp. A “user actual geographic location” might, or might not, correspond to where a user would self-report himself to be physically present.

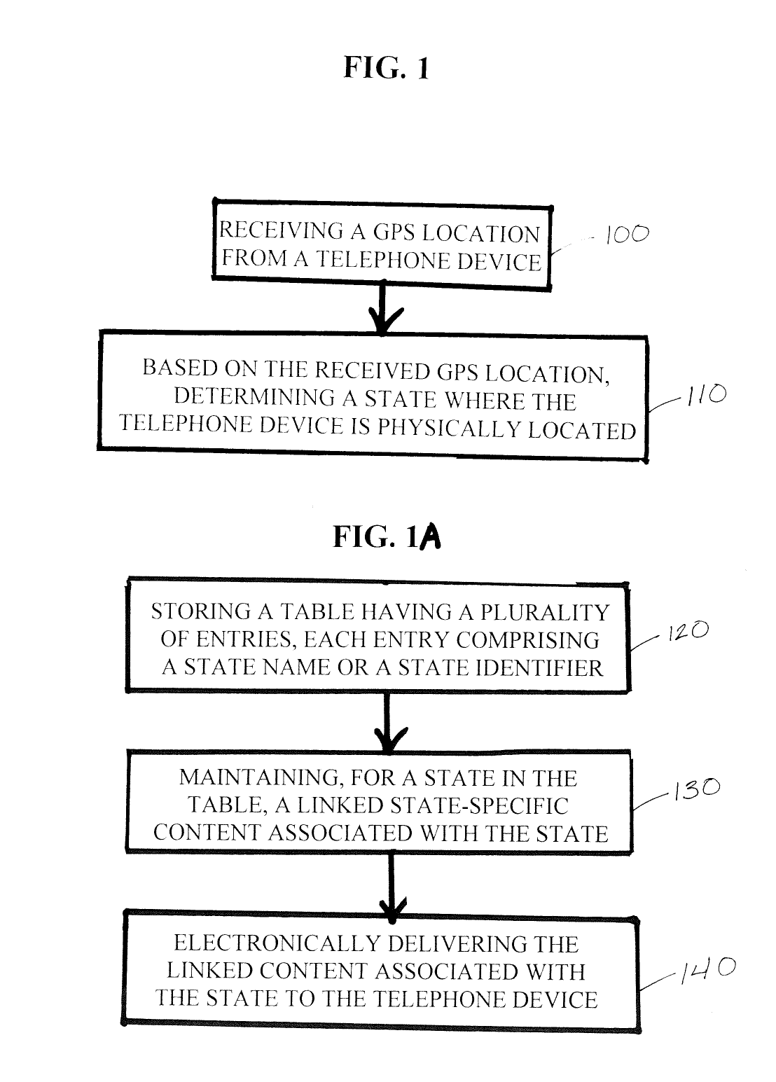

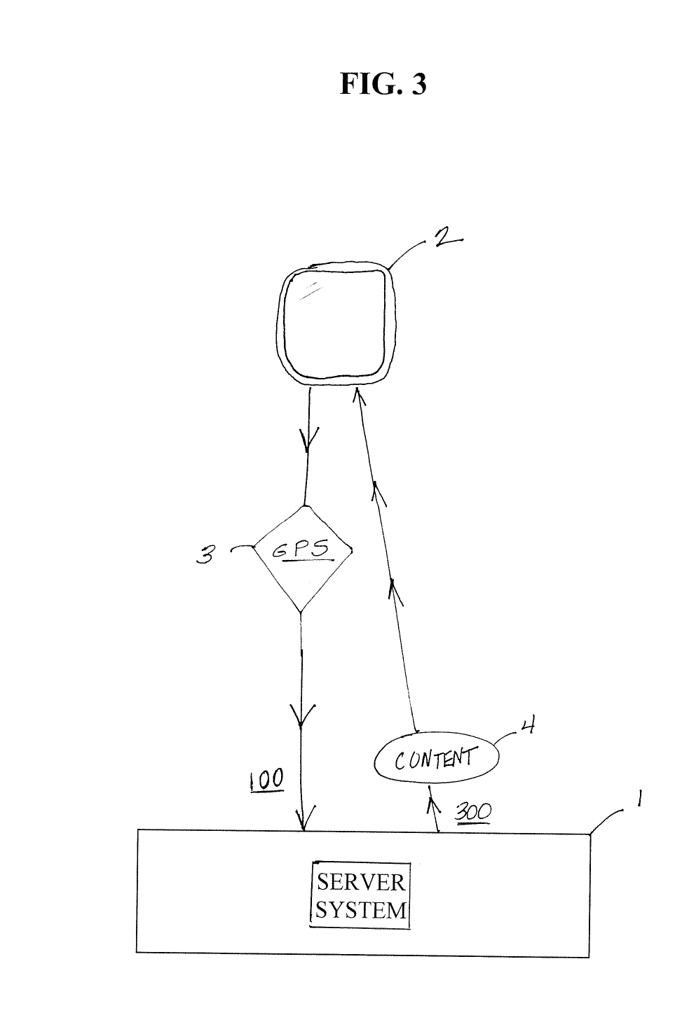

A system 1 (FIG. 3) comprising a server is established for operation by a business that processes applications, such as, e.g., a consumer-lending business, a consumer leasing business, etc., or a processor that transacts with such a business. System 1 is configured to receive inputs from, and be useable with, a plurality of mobile phone devices (f which mobile phone device 2 is illustrative), each of which is GPS-enabled. System 1 performs a step 100 (FIGS. 1 & 3) of receiving GPS coordinates 3 as automatically transmitted by telephone device 2.

System 1 receives 100 the GPS coordinates 3 from phone 2 and, after the receiving step 100, and as a function of which state (such as New Jersey, etc.) the GPS coordinates 3 represent, the system 1 performs a step 300 of sending content 4 to the phone 2. Significantly, content 4 is state-specific (most preferably, state-compliant) to the state represented by GPS coordinates 3. Namely, if GPS coordinates 3 represent a place in New York, content 4 includes content that the business considers appropriate for a New York customer, and NOT content that might be appropriate to deliver to a customer elsewhere but that could be a legal or regulatory violation for New York.

When we refer herein to a “state” or “state-”, a state within the United States, such as New Jersey, is meant.

An example of a user in the invention is, e.g., an applicant for a consumer loan (such as, e.g., a payday loan), a consumer-applicant on a lease (such as, e.g., a consumer applying for a vehicle lease, a consumer applying for an apartment lease, a consumer applying for a furniture lease, etc.), an insured submitting an insurance damage claim, etc.

The system 1 must differentially maintain content that will be used as outbound content 4 in tabulated or compartmentalized manner, so that in each case outbound content 4 can be selected for transmission as a function of what state GPS coordinates 3 are in.

System 1 must be constructed and operated so that outbound content 4 being sent to a mobile device in each case will be state-specific to the exact state where the mobile device was located when the mobile device communicated with the system 1 to request a loan application (or other application). Namely, system 1 must be constructed and operated so that wrong-state content cannot be transmitted to mobile device 2 when system 1 is replying to the incoming communication from mobile device 2.

An example of storing state-specific content in system 1 is as a library of state-specific content stored in compartmentalized manner by state. For example, New York-specific content is compartmentalized in a separate compartment than New Jersey-specific content.

Referring to FIG. 1, inventive steps in an inventive method of differential content delivery and application-processing depending on user actual geographic location in the United States are illustrated. In an inventive method, a step 100 is performed of receiving a GPS location from a telephone device. Preferably the GPS-location receiving step 100 is performed by a first computer system located at a remote location relative to the telephone device. Most preferably, the telephone device is the consumer-applicant's own mobile phone. For example, the receiving step 100 is performed as a result of the first computer prompting the consumer's mobile device to share its GPS coordinates, followed by the mobile device sharing its GPS coordinates.

As to location of the first computer system, most preferably, the first computer system is located elsewhere than at, and is NOT under control of, a lending company. Preferably the first computer system is located at, and is under control of, a processing company which is distinct from the lending company.

A step 110 is performed, based on the received GPS location from step 100, in real-time with the GPS-location receiving step, of determining a state where the telephone device is physically located. Preferably determining step 110 is performed in real-time with step 100. Preferably the determining step 110 is performed by the first computer system, namely the same computer system that performs the GPS-location receiving step.

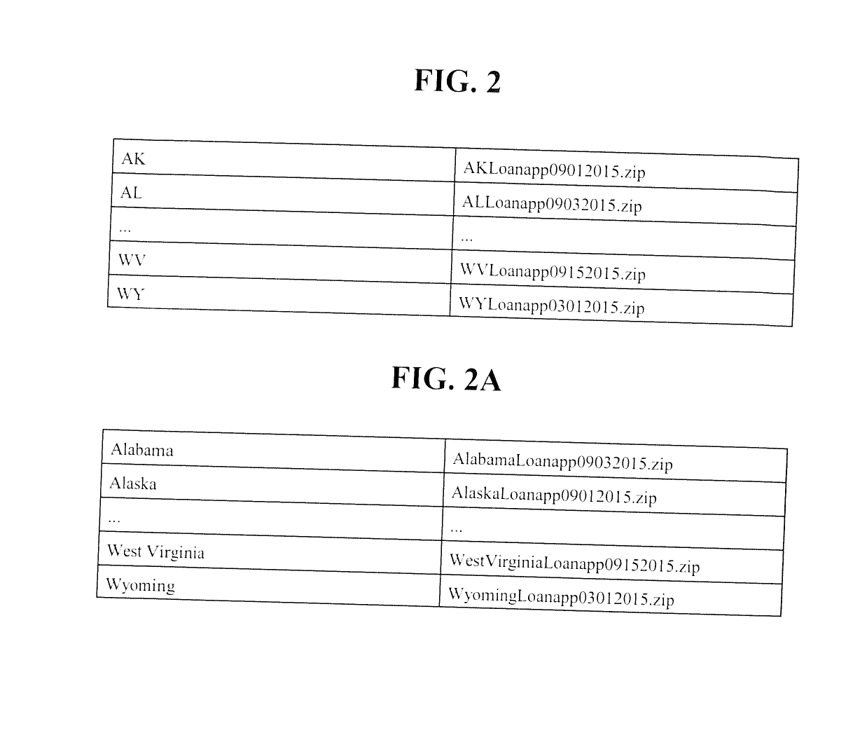

Meanwhile a step 120 is performed (preferably by the first computer system) of storing a table having a plurality of entries, each entry comprising a state name (see, e.g., state name entries in FIG. 2A) or a state identifier of a state (see, e.g., state name abbreviations in FIG. 2). An example of a state is, e.g., New Jersey. For purposes of this invention, District of Columbia is considered a state. An example of a state identifier, is, e.g., a state abbreviation (such as, e.g., NJ, VA, etc.). An example of number and type of entries in a table is, e.g., a number in a range of 2 to 51 entries, wherein each entry of the entries is for a different state.

Meanwhile a step 130 is performed of maintaining (preferably performed by the first computer system) for a state in the table, a linked state-specific content associated with the state. The linked state-specific content must have been rated as permissible, in the determination of the business, to deliver to users located in the state. In constructing the system, the linked state-specific content associated with New Jersey must be able to differ from the linked state-specific content associated with Virginia, New York, or any other state. The linked state-specific content should be susceptible of updating. Namely, as a state's laws and such change, the content that is going to be viewed by a consumer should be able to be modified and/or substituted.

After (such as, e.g., preferably within about seconds after) the determining step 110 has been performed and the state has been determined, a step 140 is performed of electronically delivering the linked content associated with the state to the telephone device. Preferably the electronically-delivering step 140 is performed by the first computer system (which preferably is a computer system of a processing company, not a company system of a lending business). Examples of state-linked content delivered in the content-delivering step 140 are, e.g., content useable for a lease (such as, e.g., a vehicle lease; a lease of a TV; etc.) to be requested; content useable for a loan (such as, e.g., a vehicle loan; an unsecured loan; a payday loan; a mortgage loan; etc.) to be requested; etc.

Examples of the content being delivered in step 140 include, e.g., instructions to the user to download an application, and a code to be entered by the user. For example, when the state-specific content that is delivered to the user's telephone device comprises a code, an example is a code that, when entered by the user into a downloaded application, connects to state-specific content specific to applicants in the state where the telephone device is then physically located.

The invention may be further appreciated with reference to the following examples without the invention being limited thereto.

### Example 1

In this example, a processing company's computer receives a GPS location from a consumer's telephone device in “State 1”. The processing company's computer electronically delivers a lending or leasing application in form appropriate for “State 1” to the consumer's telephone device. The consumer enters data into the lending or leasing application, and, application data as entered by the consumer is transmitted from the consumer's telephone device to a server of a lending company, without the consumer-entered application data reaching the processing company's computer system.

Examples of application data as entered by the consumer include, e.g., paperwork signed by the user; a photograph of a driver's license of the user; a photograph of a physical signature of the user; a photograph of the user.

### Example 1 a

In this example, the processing company's computer performs steps of: receiving from the telephone device a number of a bank account that has been entered by the user into the telephone device; delivering to the telephone device a screen seeking a fingertip signature of the user; receiving the fingertip signature of the consumer; and, after the fingertip signature of the consumer has been received by the first computer system, producing an image of a signed consumer check.

### Example 1B

In this example, after an image of a signed consumer check has been produced (such as in Example 1A), a step is performed of transmitting the image of the signed consumer check to a server of a loan or lease application company.

### Example 1C

In this example, transmitting of a signed consumer check image is performed by the user's telephone device and without the signed consumer check image being stored by the processing company's computer system.

### Example 1D

In this example, capturing a check image is performed at 200 dots per image (dpi) in black and white.

### Example 1E

In this example, displaying of a captured check image is performed, with automatically cropping content external to a predefined set of edges.

### Example 2

In this example, for state-determining step 110 to be performed, a lookup table is maintained in which each entry is a GPS coordinate, linked to a specific state.

### Example 2a

In this example, for state-determining step 110 to be performed, a lookup table is maintained in which start and stop ranges of GPS coordinates are linked to a specific state. State borders being irregularly shaped rather than perfectly rectangular, multiple GPS coordinate ranges are used to define a specific state.

### Example 3

Each loan application received by the business' automated system (such as system permanently maintained by a unique Loan ID number.

For each Loan ID number, the automated system permanently maintains a “Date Uploaded” record reflecting when the loan application was uploaded, such as, e.g., 15 Sep. 8:56 AM (2014).

For each Loan ID number, along with the “Date Uploaded” record, the automated system permanently maintains a GPS Location record, such as, e.g., 54.554, −134.937.

While the invention has been described in terms of its preferred embodiments, those skilled in the art will recognize that the invention can be practiced with modification within the spirit and scope of the appended claims.

1. A system comprising:
a computer system comprising a server system and configured to receive incoming data files from mobile telephone devices and further configured to receive GPS location data from mobile telephone devices;
a library of state-specific content stored in compartmentalized manner by state for a plurality of states S1 . . . Sn;
a plurality of mobile telephone devices M1 . . . Mn each capable of transmitting GPS location;
and wherein the computer system performs steps comprising:
receiving an incoming communication from a mobile telephone device while receiving GPS location data from the mobile telephone device;
shielding the mobile telephone device that has communicated with the computer system from being sent, in an outgoing communication by the computer system back to the mobile telephone device, any content from the library other than state-specific content from a compartment for the exact state that is the state housing the GPS coordinates of the GPS location data received from the mobile phone device.

2. The system of claim 1, wherein the state-specific content is content useable for a lease to be requested.

3. The system of claim 2, wherein the lease is selected from the group consisting of a vehicle lease; a lease of a TV.

4. The system of claim 1, wherein the state-specific content is content useable for a loan to be requested.

5. The system of claim 4, wherein the loan is selected from the group consisting of a vehicle loan; an unsecured loan; a payday loan; a mortgage loan.

6. A method of differential content delivery depending on user actual geographic location in the United States, comprising:
receiving a GPS location from a telephone device, wherein the GPS-location receiving step is performed by a first computer system;
maintaining, performed by the first computer system, in compartmentalized state-by-state manner, a series of content S1 . . . Sn, wherein the content S1 is rated as permissible to deliver to users located in State1, and content Sn is rated as permissible to deliver to users located in State “n”;
electronically delivering state-specific content to the telephone device, wherein the electronically delivering step is performed by the first computer system.

7. The method of claim 6, wherein in the GPS-location receiving step, the first computer system is located at a remote location relative to the telephone device, and the method further comprises:
based on the received GPS location, in real-time with the GPS-location receiving step, determining a state where the telephone device is physically located, wherein the determining step is performed by the first computer system;
storing, performed by the first computer system, a table having a plurality of entries, each entry comprising a state name or a state identifier of a state;
maintaining, performed by the first computer system, for a state in the table, a linked state-specific content associated with the state, wherein the content is rated as permissible to deliver to users located in the state;
within about seconds after the determining step has been performed and the state has been determined, performing the step of delivering state-specific content to the telephone device.

8. The method of claim 7, wherein the table comprises in a range of 2 to 51 entries, and wherein each entry of the entries is for a different state.

9. The method of claim 7, further comprising, after the delivering step, transmitting application data as entered by the user from the telephone device to a server of a lending company, without the user-entered application data reaching the first computer system.

10. The method of claim 7, wherein the delivered content comprises (1) instructions to the user to download an application, and (2) a code to be entered by the user.

11. The method of claim 9, wherein the application data comprises at least one selected from the group consisting of paperwork signed by the user; a photograph of a driver's license of the user; a photograph of a physical signature of the user; a photograph of the user.

12. The method of claim 7, wherein the state-specific content that is delivered to the user's telephone device comprises a code that, when entered by the user into a downloaded application, connects to state-specific content specific to applicants in the state where the telephone device is then physically located.

13. The method of claim 7, further comprising:
receiving, performed by the first computer system, from the telephone device a number of a bank account that has been entered by the user into the telephone device;
delivering, performed by the first computer system, to the telephone device a screen seeking a fingertip signature of the user;
receiving, performed by the first computer system, the fingertip signature of the consumer;
after the fingertip signature of the consumer has been received by the first computer system, producing an image of a signed consumer check, wherein the image-producing is performed by the first computer system.

14. The method of claim 13, further comprising transmitting the image of the signed consumer check to a server of the loan or lease application company.

15. The method of claim 14, wherein the transmitting of the signed consumer check image is performed by the user's telephone device and without the signed consumer check image being stored by the first computer system.

16. The method of claim 7, comprising a step of capturing, at 200 dots per image (dpi) in black and white, a check image.

17. The method of claim 15, comprising a step of displaying the captured check image, and automatically cropping content external to a predefined set of edges.
